(19) United States
(12) Patent Application Publication
(10) Pub. No.: US 2007/0160032 A1
(43) Pub. Date: Jul. 12, 2007

(54) Nif device for sigtran protocol

(75) Inventor: Won Sik Park, Ulsan (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/556,273

(22) PCT Filed: Jun. 2, 2004
(86) PCT No.: PCT/KR04/01309

§ 371 Date: Nov. 7, 2006

(30) Foreign Application Priority Data
Jun. 2, 2003 (KR) 10-2003-0035280

(51) Int. Cl. H04L 12/66; H04L 12/56; H04J 3/16

(52) U.S. Cl. 370/352; 370/389; 370/466

(57) ABSTRACT

The present invention relates to an apparatus implementing a SIGTRAN protocol comprising an NIF device coupled between an SS7 network and an IP network. If the NIF device receives messages of MTP2/MTP3/SCCP from the SS7 network, the NIF device defines the types of messages by reading integer values inserted in the messages of MTP2/MTP3/SCCP and simultaneously performs respective primitive conversion functions corresponding to the types of the messages. If the NIF device receives messages of M2UA/M3UA/SUA from the IP network, the NIF device defines the types of messages by reading a common message header contained commonly in the messages of M2UA/M3UA/SUA, performs primitive conversion functions corresponding to the types of messages and transmits the primitives to the SS7 network. The NIF device can be used for all the layers. In accordance with the present invention, it is possible to solve troublesome problems in establishing respective NIF devices for all the layers and expand the flexibility of the software.

### TECHNICAL FIELD

The present invention relates to a Nodal Interworking Function (NIF) device implementing a signaling transport (SIGTRAN) protocol, and more particularly to an NIF device implementing the SIGTRAN protocol that is capable of transmitting messages in all layers of the protocol by defining a message type and performing a conversion of the primitive corresponding to the layer between Signaling System No. Seven (SS7) and Internet Protocol (IP) networks.

### BACKGROUND ART

In conventional technology, a Transmission Control Protocol/Internet Protocol (TCP/IP) stack is used to transmit information from a Switched Circuit Network (SCN) to an IP network. However, the TCP network has limitations, such as head-of-line-blocking and requirement to use only one IP. Thus the TCP network has a shortcoming in transmitting information during the call processing. In order to overcome the limitations of the TCP network, a SIGTRAN protocol having a Stream Control Transmission Protocol, which uses multi-streams and multi-homing, has been required.

In the SIGTRAN protocol mentioned above, a signaling gateway (SG) transmits signals between the IP and the SCN networks, and NIF devices are needed to convert the signals of the networks. However, the problem is that separated NIF devices must be provided to the MTP2/MTP3/SCCP in order to connect the SIGTRAN protocol to other networks. Here, MTP2, MTP3 and SCCP denote, respectively, a message transfer part of level 2, a message transfer part of level 3 and the Signaling Connection Control Protocol.

### DISCLOSURE OF THE INVENTION

It is, accordingly, an object of the present invention to provide an apparatus implementing a SIGTRAN protocol, including one NIF device capable of performing appropriate processing according to the characteristics of the layers, changing conversion modes according to differences between messages generated from the layers and being used for the processing in all the layers.

In accordance with an embodiment of the present invention, there is provided an apparatus implementing a SIGTRAN protocol comprising an NIF device coupled between an SS7 network consisting of SSP, MTP3, MTP2 and MTP1 and an IP network consisting of M2UA, M3UA and SUA for transmitting call process messages, wherein if the NIF device receives messages of MTP2/MTP3/SCCP from the SS7 network, the NIF device defines the types of messages by reading integer values inserted in the messages of the MTP2/MTP3/SCCP and simultaneously performs respective primitive conversion functions corresponding to the types of the messages; and

if the NIF device receives messages of M2UA/M3UA/SUA from the IP network, the NIF device defines the types of the messages by reading a common message header contained in the messages of the M2UA/M3UA/SUA, performs respective primitive conversion functions corresponding to the types of the messages and transmits the primitives to the SS7 network.

### BRIEF DESCRIPTION OF DRAWINGS

FIG. 1 shows a schematic configuration of an NIF device implementing a SIGTRAN protocol according to an embodiment of the present invention;

FIG. 2 is a diagram illustrating a classification process of messages and a conversion process of the primitives in the NIF device shown in FIG. 1;

FIG. 3 shows a schematic diagram illustrating a real network configuration of the NIF device shown in FIG. 1; and

FIG. 4 is a diagram showing a common message header that exists in the adaptation layers M2UA/M3UA/SUA in accordance with the present invention.

### BEST MODE FOR CARRYING OUT THE INVENTION

The embodiment of the present invention will be described with reference to the accompanying drawings.

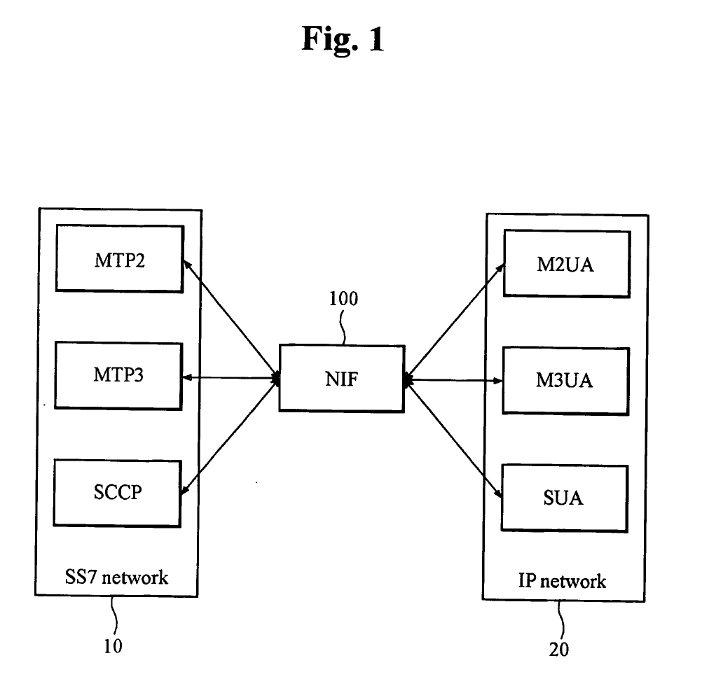

FIG. 1 shows a schematic configuration of an NIF device implementing a SIGTRAN protocol according to an embodiment of the present invention. FIG. 3 shows a schematic diagram illustrating a real network configuration of the NIF device. NIF device 100 implementing the SIGTRAN protocol according to an embodiment of the present invention consists of MTP1 layer process unit 101, MTP2/MTP3/SCCP layer process unit 102, SCTP layer process unit 103 and M2UA/M3UA/SUA layer process unit 104. Here, MTP1, MTP2 and MTP3 denote, respectively, message transfer parts of level 1, level 2 and level 3, and SCTP denotes a Stream Control Transmission Protocol.

NIF device 100 is coupled between SS7 network 10 and IP network 20. If NIF device 100 receives messages of MTP2/MTP3/SCCP from SS7 network 10, the NIF device defines the types of the messages by reading integer values inserted in the messages and simultaneously performs respective primitive conversion functions corresponding to the types of the messages, and outputs the primitives to IP network 20. If the NIF device receives messages of M2UA/M3UA/SUA from IP network 20, the NIF device defines the types of the messages by reading a common message header contained in the messages, performs respective primitive conversion functions corresponding to the types of the messages and transmits the primitives to SSP network 10.

MTP1 layer processing unit 101 of NIF device 100 receives the messages of MTP2/MTP3/SCCP from the SS7 network through an SS7 link and outputs the messages of MTP2/MTP3/SCCP to MTP2/MTP3/SCCP layer 102.

MTP2/MTP3/SCCP layer processing unit 102 of NIF device 100 receives the messages of MTP2/MTP3/SCCP from MTP1 layer processing unit 101, defines the types of the messages corresponding to the messages, performs the primitive conversion functions and outputs the primitives to M2UA/M3UA/SUA layer processing unit 104.

SCTP layer processing unit 103 of NIF device 100 receives the messages of M2UA/M3UA/SUA from the IP network and outputs the messages of M2UA/M3UA/SUA to M2UA/M3UA/SUA layer processing unit 104.

M2UA/M3UA/SUA layer processing unit 104 receives the messages of M2UA/M3UA/SUA from SCTP layer processing unit 103, defines the types of the messages corresponding to the messages, performs the primitive conversion functions and outputs the primitives to MTP2/MTP3/SCCP layer processing unit 102.

Two modes of primitive conversion functions are performed in NIF device 100: a conversion from SSP network 10 to IP network 20 and a conversion from IP network 20 and to SSP network 10. In both primitive conversion functions, it is required to classify the layer depending upon where the layer message comes from.

Namely, the messages of MTP2/MTP3/SCCP layers are classified in SS7 network 10 and the messages of M2UA/M3UA/SUA layers are classified in IP network 20. Thereafter, the conversion functions of the primitives are performed. At this time, signaling gate SG plays the role of transmitting messages between SS7 network 10 and IP network, and thus the primitive conversions, from DATA REQ to DATA IND and from DATA IND to DATA REQ, are performed in the SG.

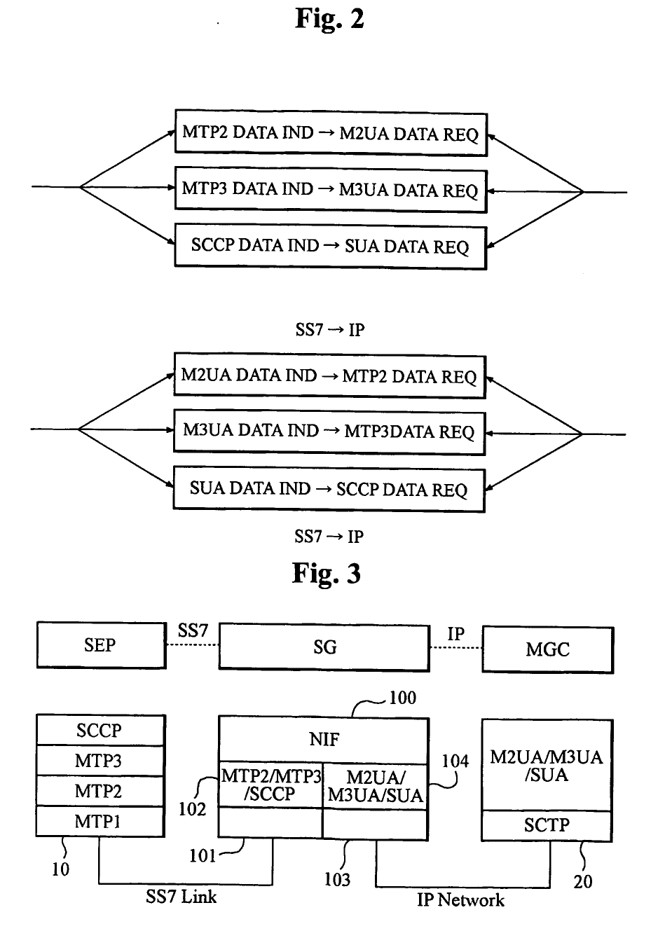

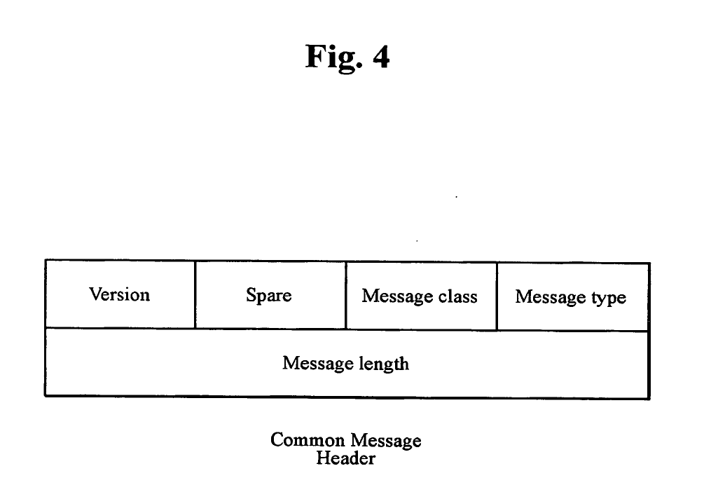

FIG. 2 is a diagram illustrating a classification process of the messages and a conversion process of the primitives in the NIF device shown in FIG. 1. FIG. 4 shows a common message header, which exists in the adaptation layers M2UA/M3UA/SUA in accordance with the present invention.

In NIF device 400, the classification of the messages and the conversions of the primitives are performed by using class values of the message, with reference to the message header shown in FIG. 4.

### INDUSTRIAL APPLICABILITY

According to the NIF device implementing the SIGTRAN protocol of the present invention, the types of messages are defined by the layers, and the messages of the layers are transmitted by performing a conversion of the primitives corresponding to the layers between the SS7 network and the IP network. Therefore, only one NIF device need be used for all the layers. Further, it is possible to solve troublesome problems in establishing respective NIF devices for all the layers and expand the flexibility of the software.

1. An apparatus implementing a SIGTRAN protocol comprising an NIF device coupled between an SS7 network comprising SSP, MTP3, MTP2 and MTP1 and an IP network comprising M2UA, M3UA and SUA for transmitting call process messages, wherein
if the NIF device receives messages of MTP2/MTP3/SCCP from the SS7 network, the NIF device defines types of messages by reading integer values inserted in the messages and simultaneously performs primitive conversion functions corresponding to the types of messages, and
if the NIF device receives messages of M2UA/M3UA/SUA from the IP network, the NIF device defines the types of messages by reading a common message header contained in the messages, performs primitive conversion functions corresponding to the types of messages and transmits the primitives to the SS7 network.

2. The apparatus of claim 1, wherein the NIF device includes:
an MTP1 layer processing unit for receiving the messages of MTP2/MTP3/SCCP from the SS7 network through an SS7 link and outputting the messages;
an MTP2/MTP3/SCCP layer processing unit for receiving the messages of MTP2/MTP3/SCCP from the MTP1 layer processing unit, defining the types of messages corresponding to the messages of MTP2/MTP3/SCCP, performing the primitive conversion functions and outputting the primitives;
an SCTP layer processing unit for receiving the messages of M2UA/M3UA/SUA from the IP network through an IP network and outputting the messages of M2UA/M3UA/SUA; and
an M2UA/M3UA/SUA layer processing unit for receiving the messages of M2UA/M3UA/SUA from the SCTP layer processing unit, defining the types of messages corresponding to the messages of M2UA/M3UA/SUA, performing the primitive conversion functions and outputting the primitives to the MTP2/MTP3/SCCP layer processing unit.
